(19) United States
(12) Patent Application Publication
(10) Pub. No.: US 2005/0070303 A1
(43) Pub. Date: Mar. 31, 2005

(54) Level of service in a wireless telecommunications network

(76) Inventors: Barbara Jean Lagno, Point Pleasant, NJ (US); Constantine N. K. Osiakwan, Jackson, NJ (US); Gregory John Sturgis, Freehold, NJ (US); Marian Jerzy Zarnowski, Longmont, CO (US); Adonny William Raphael, Holmdel, NJ (US)

Correspondence Address: DEMONT & BREYER, LLC, SUITE 250, 100 COMMONS WAY, HOLMDEL, NJ, 07733, US

(21) Appl. No.: 10/675,067

(22) Filed: Sep. 30, 2003

(51) Int. Cl. H04M 1/00

(52) U.S. Cl. 455/456.1; 455/566

(57) ABSTRACT

A technique is disclosed for improving the process of finding a location in a network from which to communicate with a wireless terminal and with a particular level of service. The illustrative embodiment of the present invention uses measurements associated with one or more wireless terminals in the network to determine a suitable location. The measurements are performed on electromagnetic signals radiated by each wireless terminal or from another source and are evaluated against characteristics such as throughput, error rate, and latency.

### FIELD OF THE INVENTION

The present invention relates to telecommunications in general, and, more particularly, to wireless networks.

### BACKGROUND OF THE INVENTION

FIG. 1 depicts a first schematic diagram of network 100 in the prior art. Network 100 comprises wireless terminals 101-1 through 101-4, which are communications devices capable of voice, data, and video. Examples of such devices include wireless telephones (e.g., cellular handsets, cordless handsets, etc.), computers (e.g., laptops, etc.) with wireless local area network capability, and wireless personal digital assistants. Wireless terminals 101-1 through 101-4 communicate with each other within area 102.

Area 102 defines a region in which wireless terminals 101-1 through 101-3 can communicate with wireless terminal 101-4 with a particular level of service. A particular level of service refers to a distinct point or range of quality in communications, which is usually defined by the network operator, the wireless terminal user, or both. Level of service is measured in terms of one or more of the following characteristics, although other characteristics might also apply:
i) throughput, which is the amount of information transmitted;
ii) error rate, which is the ratio of the number of incorrect elements transmitted to the total number of elements transmitted; and
iii) latency, which is the time it takes for the information transmitted to get through a network. This characteristic includes temporal variations in latency such as jitter.

Because wireless terminals 101-1 through 101-3 are situated within area 102, they are able to communicate with wireless terminal 101-4 with the particular level of service associated with area 102.

Wireless terminal 101-4 is significant because in some operational scenarios it serves to identify network 100 to other wireless terminals. For example, wireless terminal 101-4 might be the access point in an Institute of Electrical and Electronics Engineers (IEEE) 802.11 coverage area, the coverage area being sometimes referred to as a “WiFi hotspot.” Since an access point enables a wireless terminal to communicate with other wireless terminals and other networks, it is important to know if the wireless terminal can communicate with a particular level of service.

FIG. 2 depicts a second schematic diagram of local area network 100 in the prior art. Wireless terminal 201-1 is situated within area 102 and, as a result, is able to communicate with wireless terminal 101-4 with the particular level of service associated with area 102. Wireless terminal 201-2, however, is situated outside of area 102 and, as a result, is not able to communicate with wireless terminal 101-4 with the particular level of service associated with area 102. Moreover, if wireless terminal 201-2 could move into the region defined by area 102, it could communicate with wireless terminal 101-4 with the particular level of service associated with area 102.

Different techniques exist for the purpose of bringing wireless terminals into the proximity of wireless terminal 101-4. In the first technique in the prior art, wireless terminal 101-4 is prominently identified so that the user of wireless terminal 201-2 can move closer to wireless terminal 101-4 and possibly communicate with an improved level of service. The advantage of this technique is that it is simple, requiring as little as a sign that identifies wireless terminal 101-4's location. The disadvantage of this technique is that a sign identifying wireless terminal 101-4's location often cannot be displayed in plain view to all users. An example of this is in a crowded airport terminal, in which there are many sights and sounds competing for the attention of the user.

In the second technique in the prior art, wireless terminal 201-2's user can be informed that i) the level of service is inadequate at his or her present location and that ii) wireless terminal 201-2 should be moved a few feet elsewhere. This task is repeated until the user finds a location with an adequate level of service. The advantage of this technique is that the user is given updates on each new location. The disadvantage of this technique is that the user could be bouncing back and forth from one location to another without converging quickly enough, if at all, on a satisfactory location.

What is needed is a technique to improve the process of finding a location from which to communicate with a wireless terminal and with a particular level of service, but without the disadvantages of the prior art.

### SUMMARY OF THE INVENTION

The technique of the present invention improves the process of finding a location from which to communicate with a wireless terminal and with a particular level of service, but without some of the costs and disadvantages associated with doing so in the prior art. In accordance with the illustrative embodiment of the present invention, a network determines that one or more wireless terminals at known locations are able to communicate, or have been able to communicate, with a specific wireless terminal, such as an access point, with a particular level of service. The particular level of service might be characterized, for example, as being less than 100 milliseconds of latency, being greater than two megabits per second throughput, etc. In accordance with the illustrative embodiment, the network informs a wireless terminal needing to communicate with the access point where to expect performance at the particular level of service, based on the locations of the other wireless terminals.

In accordance with the illustrative embodiment, a wireless network's access point measures the level of service that it is able to provide to each wireless terminal in its purview and correlates that level of service to the location of the wireless terminal. The access point then transmits data that correlates level of service to location to all of the terminals within it's purview so that they know where they can be and get a desired level of service.

In different embodiments, the network determines performance in different ways. The access point, in some embodiments, measures electromagnetic signals transmitted by the wireless terminals in the network. Each wireless terminal, in other embodiments, provides to the access point measurements of electromagnetic signals transmitted by a source. The access point uses the measurement information to determine the performance, relative to particular levels of service, that the wireless terminals are experiencing and provides that information to a selected wireless terminal for the purpose of informing its user (e.g., through a graphical map displayed, etc.).

An illustrative embodiment of the present invention comprises: determining that a first wireless terminal at a location can communicate with a second wireless terminal with a level of service; and transmitting to a third wireless terminal an indication that the third wireless terminal should be able to communicate with the second wireless terminal with the level of service at the location.

### BRIEF DESCRIPTION OF THE DRAWINGS

FIG. 1 depicts a schematic diagram of network 100 in the prior art, in which all wireless terminals are inside area 102.

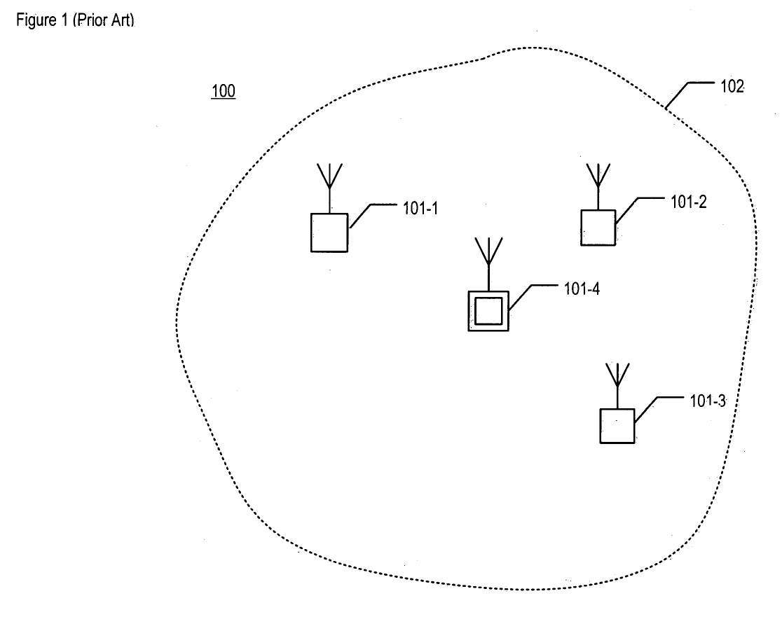

FIG. 2 depicts a schematic diagram of network 100 in the prior art, in which wireless terminal 201-2 is outside of area 102.

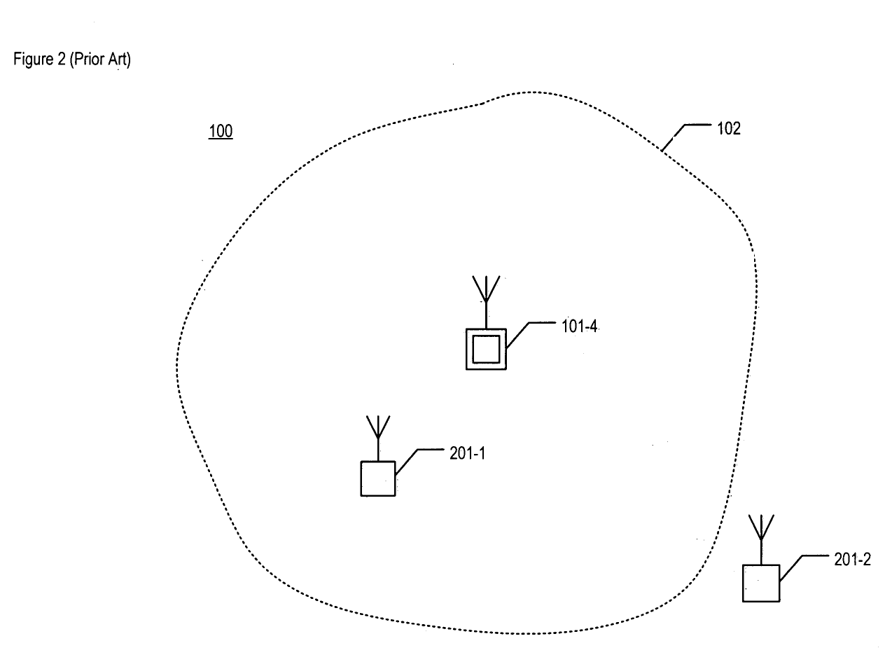

FIG. 3 depicts a schematic diagram of a portion of network 300 in accordance with the illustrative embodiment of the present invention.

FIG. 4 depicts a block diagram of the salient components of wireless terminal 301-i in accordance with the illustrative embodiment of the present invention.

FIG. 5 depicts a flowchart of the salient tasks performed by network 300 in accordance with the first illustrative embodiment of the present invention.

FIG. 6 depicts a flowchart of the salient tasks performed by wireless terminal 301-i in accordance with the second illustrative embodiment of the present invention.

FIG. 7 depicts a flowchart of the salient tasks performed by wireless terminal 301-i in accordance with the third illustrative embodiment of the present invention.

FIG. 8 depicts an illustrative example of wireless terminals in network 800, in accordance with the illustrative embodiment of the present invention.

FIG. 9 depicts a first example of a graphical map generated from wireless terminal locations, in accordance with the illustrative embodiment of the present invention.

FIG. 10 depicts a second example of a graphical map generated from wireless terminal locations as a function of time, in accordance with the illustrative embodiment of the present invention.

FIG. 11 depicts a third example of a graphical map generated from wireless terminal locations as a function of capability of the displaying wireless terminal, in accordance with the illustrative embodiment of the present invention.

### DETAILED DESCRIPTION

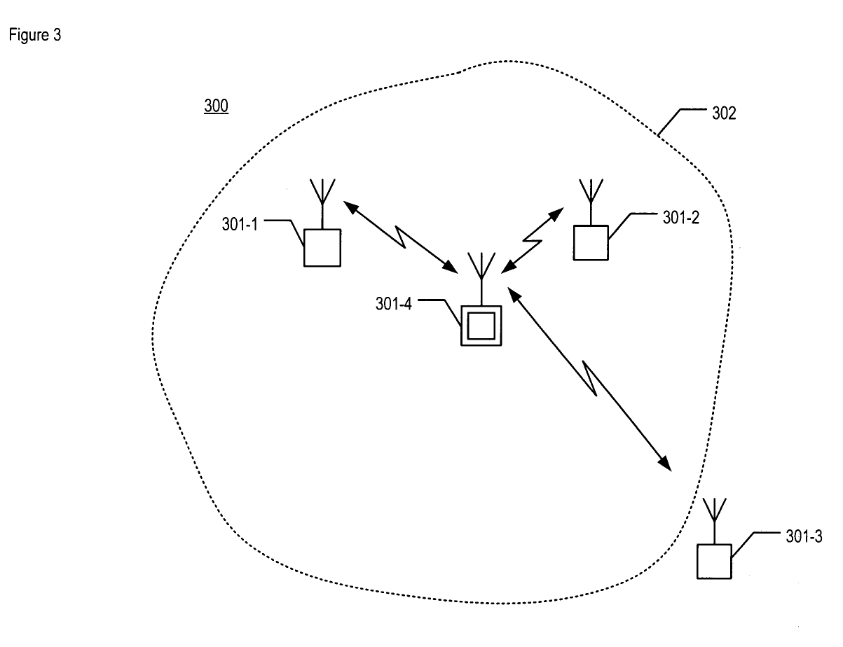

FIG. 3 depicts a schematic diagram of network 300 in accordance with the illustrative embodiment of the present invention. Network 300 can be a wireless local area network, a cellular network, or some other type of communications network. Network 300 operates in accordance with a set of protocols (e.g., IEEE 802.11, CDMA2000, Bluetooth, etc.) and comprises wireless terminals 301-1 through 301-4, linked wirelessly as shown. Also, it will be clear to those skilled in the art how to make and use network 300 comprising a different number of wireless terminals.

Wireless terminals 301-1 through 301-3 are able to communicate with wireless terminal 301-4. In particular, wireless terminals 301-1 and 301-2 are located within area 302 and, as a result, are able to communicate with wireless terminal 301-4 with a particular level of service.

A particular level of service refers to a distinctive point or range of quality in communications, which is usually defined by the network operator, the wireless terminal user, or both in well-known fashion. Level of service is measured in terms of one or more of the following characteristics known in the art:
i) throughput,
ii) error rate (e.g., bit error rate, frame error rate, etc.), and
iii) latency, including the variation of latency.
   It will be clear to those skilled in the art how to apply characteristics other than those listed above in measuring level of service, alone or in combination with those listed.

In contrast to wireless terminals 301-1 and 301-2, wireless terminal 301-3 is not situated within area 302, so it is not able to communicate with wireless terminal 301-4 with the particular level of service associated with area 302.

In the illustrative example depicted in FIG. 3, wireless terminal 301-4 is an access point, the device that provides, for example, an IEEE 802.11 coverage area. As an access point, wireless terminal 301-4 enables wireless terminals 301-1 through 301-3 to communicate with each other though wireless terminal 301-4. Furthermore, wireless terminal 301-4 enables wireless terminals 301-1 through 301-3 to communicate with devices in communications networks other than network 300. Note that the presence of an access point does not by itself guarantee communication with a particular level of service. It will be clear to those skilled in the art how to make and use an access point.

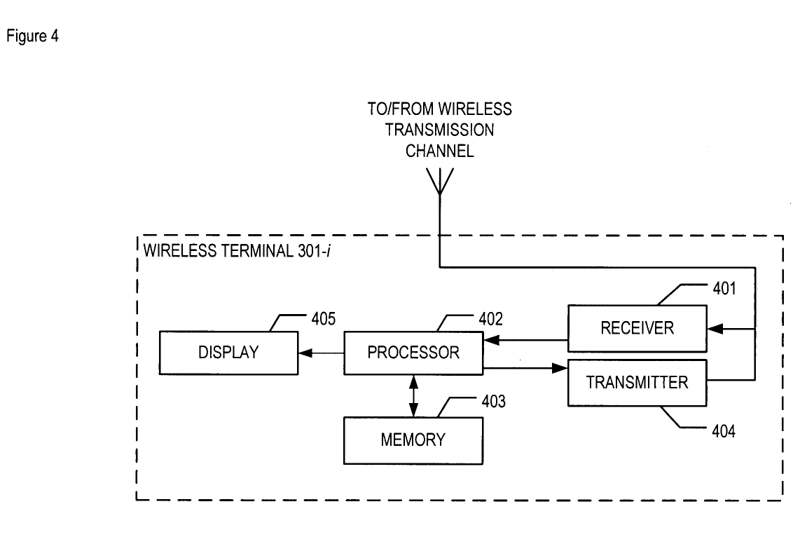

FIG. 4 depicts a block diagram of the salient components of wireless terminal 301-i, for i=1 to L, wherein L is a positive integer (i.e., equal to four in FIG. 3), in accordance with the illustrative embodiment of the present invention. Wireless terminal 301-i comprises receiver 401-i, processor 402-i, memory 403-i, transmitter 404-i, and display 405-i, interconnected as shown.

Receiver 401-i is a circuit that is capable of receiving frames from a wireless transmission channel, in well-known fashion, and of forwarding them to processor 402-i. It will be clear to those skilled in the art how to make and use receiver 401-i.

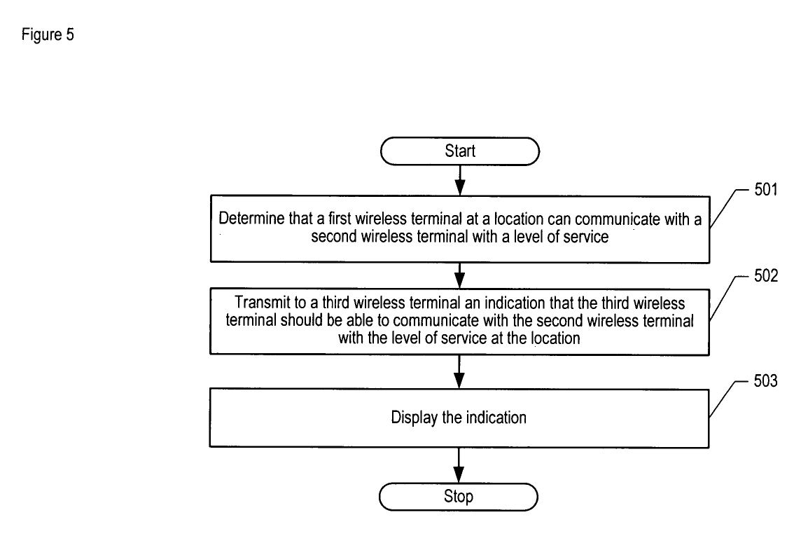

Processor 402-i is a general-purpose processor that is capable of performing the tasks described below and with respect to FIG. 5 through 11. It will be clear to those skilled in the art, after reading this specification, how to make and use processor 402-i.

Memory 403-i is capable of storing programs and data used by processor 402-i. It will be clear to those skilled in the art how to make and use memory 403-i.

Transmitter 404-i is a circuit that is capable of receiving frames from processor 402-i, in well-known fashion, and of transmitting them into the wireless transmission channel. It will be clear to those skilled in the art how to make and use transmitter 404-i.

Display 405-i is capable of displaying information received from other wireless terminals (e.g., wireless terminal 301-4, etc.) through processor 402-i. In some embodiments, such as where wireless terminal 301-i is an access point, display 405-i is not present. It will be clear to those skilled in the art, after reading this specification, how to make and use display 405-i.

FIG. 5 depicts a flowchart of the operation of the first illustrative embodiment of the present invention. It will be clear to those skilled in the art which tasks depicted in FIG. 5 can be performed simultaneously or in a different order than that depicted. As an illustrative example, wireless terminals 301-1, 301-3, and 301-4 perform the tasks depicted. It will be clear however to those skilled in the art, after reading this specification, how other combinations of wireless terminals can perform the tasks depicted in FIG. 5.

At task 501, network 300 determines that wireless terminal 301-1 can communicate with wireless terminal 301-4 with a first level of service. Wireless terminal 301-4 or another element within network 300 can determine this, alone or in combination with each other. Alternatively, some other element outside of network 300 can determine, or assist in determining, that wireless terminal 301-1 can communicate with wireless terminal 301-4.

The determining task, in some embodiments, comprises measuring a signal associated with wireless terminal 301-1. The signal is transmitted by wireless terminal 301-1 or received by wireless terminal 301-1. The measurement is evaluated against a threshold of a characteristic described earlier that defines the first level of service. For example, if the characteristic is throughput, the network could determine that the signal is consistent with the particular level of service for throughput if the measurement is two megabits per second (i.e., the exemplary threshold) or greater. It will be clear to those skilled in the art how to measure and evaluate a signal.

In some embodiments, multiple measurements are combined (e.g., averaged, etc.) in well-known fashion. The result of the combining, rather than a single measurement, is then evaluated against the threshold.

The determining task further comprises determining the location of wireless terminal 301-1. In some embodiments, this is accomplished by taking a Global Positioning System (GPS) measurement of wireless terminal 301-1 in well-known fashion. It will be clear to those skilled in the art how to determine the location of wireless terminal 301-1.

In some embodiments, the time that the determining task is performed is determined in well-known fashion.

At task 502, an element in network 300 (e.g., wireless terminal 301-4, etc.) transmits to wireless terminal 301-3 an indication that wireless terminal 301-3 should be able to communicate with wireless terminal 301-4 both i) with the first level of service and ii) at the location determined at task 501. It will be clear to those skilled in the art how to represent and transmit the indication.

In some embodiments, an element in network 300 (e.g., wireless terminal 301-4, etc.) transmits an indication that wireless terminal 301-3 should be able to communicate with wireless terminal 301-4 with the first level of service and at one or more other locations than that determined at task 501. Those other locations, for example, can include the location of wireless terminal 301-2.

An element in network 300 (e.g., wireless terminal 301-4, etc.), in some embodiments, transmits an indication that wireless terminal 301-3 should be able to communicate with wireless terminal 301-4 with a second level of service. For example, if the first level of service is evaluated in terms of meeting a latency characteristic, the second level of service can be evaluated in terms of meeting a throughput characteristic. It will be clear to those skilled in the art, after reading this specification, how to determine that wireless terminal 301-1 can communicate with wireless terminal 301-4 with a second level of service, in addition to a first level of service.

At task 503, in some embodiments, an element in network 300 (e.g., wireless terminal 301-3, etc.) displays the indication transmitted at task 502. In some embodiments, the displaying of the indication occurs in the form of a graphical map. The graphical map portrays the location determined at task 501. The graphical map can also include the locations of other wireless terminals (e.g., wireless terminal 301-2, etc.) that are able to communicate with the level of service or with other levels of service or both.

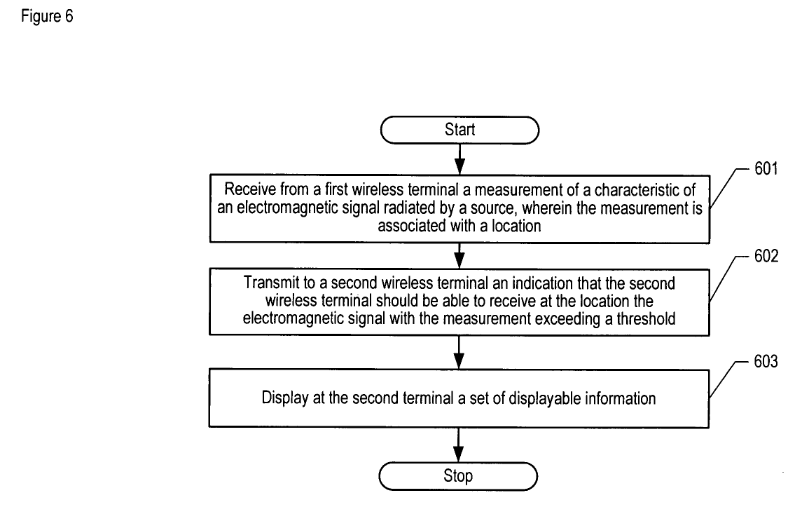

FIG. 6 depicts a flowchart of the operation of the second illustrative embodiment of the present invention. It will be clear to those skilled in the art which tasks depicted in FIG. 6 can be performed simultaneously or in a different order than that depicted. As an illustrative example, wireless terminals 301-1, 301-3, and 301-4 perform the tasks depicted. It will be clear however to those skilled in the art, after reading this specification, how other combinations of wireless terminals can perform the tasks depicted in FIG. 6.

At task 601, an element in network 300 (e.g., wireless terminal 301-4, etc.) receives from wireless terminal 301-1 a measurement of a first characteristic of an electromagnetic signal radiated by a source. The measurement is associated with a location, such as the location of wireless terminal 301-1 where wireless terminal 301-1 takes the measurement. In some embodiments, the source is an access point.

The electromagnetic signal, in some embodiments, conveys a data block (e.g., part or all of a frame, etc.) transmitted by the source. In other embodiments, the data block constitutes a beacon frame. It will be clear to those skilled in the art how to format and use a beacon frame.

The set of characteristics in the illustrative embodiment comprises, but is not limited to, i) throughput, ii) error rate, iii) latency, and iv) signal strength. In some embodiments, an element in network 300 (e.g., wireless terminal 301-4, etc.) compares the measurement of the first characteristic against a threshold in well-known fashion to determine if the measurement exceeds the threshold. For example, if the first characteristic is throughput, the threshold might be set at two megabits per second. If the measurement is two megabits per second or greater, then the measurement is said to exceed the threshold.

In some embodiments, multiple measurements are combined (e.g., averaged, etc.) in well-known fashion and then the result is evaluated against the threshold.

Network 300 determines the location of wireless terminal 301-1. In some embodiments, this is accomplished by taking a Global Positioning System (GPS) measurement of wireless terminal 301-1 in well-known fashion. It will be clear to those skilled in the art how to determine the location of wireless terminal 301-1.

In some embodiments, network 300 determines in well-known fashion the time that the measurement is taken.

At task 602, an element in network 300 (e.g., wireless terminal 301-4, etc.) transmits to wireless terminal 301-3 an indication that wireless terminal 301-3 should be able to receive at the determined location the electromagnetic signal with the first characteristic exceeding the threshold described earlier. It will be clear to those skilled in the art how to format and transmit the indication.

In some embodiments, an element in network 300 (e.g., wireless terminal 301-4, etc.) transmits an indication that wireless terminal 301-3 should be able to communicate with wireless terminal 301-4 at one or more other locations than that determined at task 601. Those other locations, for example, can include the location of wireless terminal 301-2.

In other embodiments, an element in network 300 (e.g., wireless terminal 301-4, etc.) transmits an indication that wireless terminal 301-3 should be able to receive at the determined location the electromagnetic signal with a measurement of a second characteristic exceeding a threshold. For example, if the first characteristic is throughput, the second characteristic can be latency. It will be clear to those skilled in the art, after reading this specification, how to determine that wireless terminal 301-1 can communicate with wireless terminal 301-4 with the measurement of the second characteristic exceeding a threshold, in addition to the measurement of the first characteristic exceeding its threshold.

In some embodiments, the indication transmitted at task 602 constitutes a set of displayable information, wherein the set of displayable information comprises the determined location. At task 603 in some embodiments, wireless terminal 301-3 displays the set of displayable information. In some embodiments, the set of displayable indication is in the form of a graphical map. The graphical map can portray the location determined at task 601. The graphical map can also portray the locations of other wireless terminals (e.g., wireless terminal 301-2, etc.) that are able to communicate with wireless terminal 301-4.

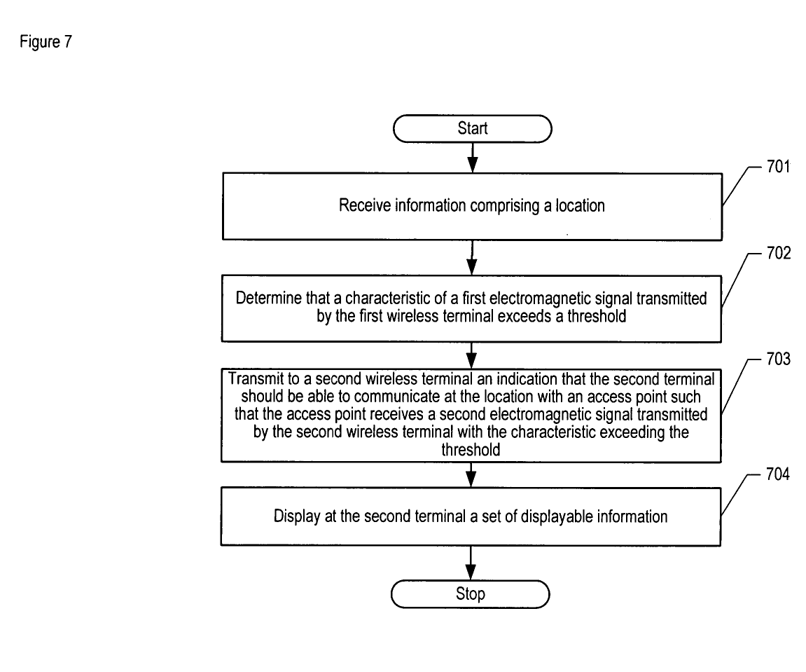

FIG. 7 depicts a flowchart of the operation of the third illustrative embodiment of the present invention. It will be clear to those skilled in the art which tasks depicted in FIG. 7 can be performed simultaneously or in a different order than that depicted. As an illustrative example, wireless terminals 301-1, 301-3, and 301-4 perform the tasks depicted. It will be clear however to those skilled in the art, after reading this specification, how other combinations of wireless terminals can perform the tasks depicted in FIG. 7.

At task 701, an element in network 300 (e.g., wireless terminal 301-4, etc.) receives information comprising a location. The location, in some embodiments, corresponds to the location of wireless terminal 301-1. In some embodiments, the location is determined by taking a Global Positioning System (GPS) measurement of wireless terminal 301-1 in well-known fashion. It will be clear to those skilled in the art how to determine the location of wireless terminal 301-1.

At task 702, wireless terminal 301-4 measures a first characteristic of an electromagnetic signal transmitted by wireless terminal 301-1. The electromagnetic signal, in some embodiments, conveys a data block (e.g., part or all of a frame, etc.) transmitted by wireless terminal 301-1.

The set of characteristics in the illustrative embodiment comprises, but is not limited to, i) throughput, ii) error rate, iii) latency, and iv) signal strength. In some embodiments, an element in network 300 (e.g., wireless terminal 301-4, etc.) compares the measurement of the first characteristic against a threshold in well-known fashion to determine if the measurement exceeds the threshold.

In some embodiments, multiple measurements are combined (e.g., averaged, etc.) in well-known fashion and then the result is evaluated against the threshold.

Network 300, in some embodiments, determines in well-known fashion the time that the measurement is taken.

At task 703, an element in network 300 (e.g., wireless terminal 301-4, etc.) transmits to wireless terminal 301-3 an indication that wireless terminal 301-3 should be able to communicate at the determined location with an access point. Moreover, the access point would receive an electromagnetic signal transmitted by wireless terminal 301-3 at the determined location with the first characteristic exceeding the threshold described earlier. It will be clear to those skilled in the art how to transmit the indication.

In some embodiments, an element in network 300 (e.g., wireless terminal 301-4, etc.) transmits an indication that wireless terminal 301-3 should be able to communicate with wireless terminal 301-4 at one or more other locations than that determined at task 701. Those other locations, for example, can include the location of wireless terminal 301-2.

In other embodiments, an element in network 300 (e.g., wireless terminal 301-4, etc.) transmits an indication that the access point would receive an electromagnetic signal transmitted by wireless terminal 301-3 with a second characteristic exceeding a threshold. For example, if the first characteristic is throughput, the second characteristic can be latency. It will be clear to those skilled in the art, after reading this specification, how to determine that wireless terminal 301-1 can communicate with wireless terminal 301-4 with the measurement of the second characteristic exceeding a threshold, in addition to the measurement of the first characteristic exceeding its threshold.

In some embodiments, the indication transmitted at task 703 constitutes a set of displayable information, wherein the set of displayable information comprises the determined location. At task 704 in some embodiments, wireless terminal 301-3 displays the set of displayable information. In some embodiments, the set of displayable indication is in the form of a graphical map. The graphical map can portray the location determined at task 701. The graphical map can also portray the locations of other wireless terminals (e.g., wireless terminal 301-2, etc.) that are able to communicate with wireless terminal 301-4.

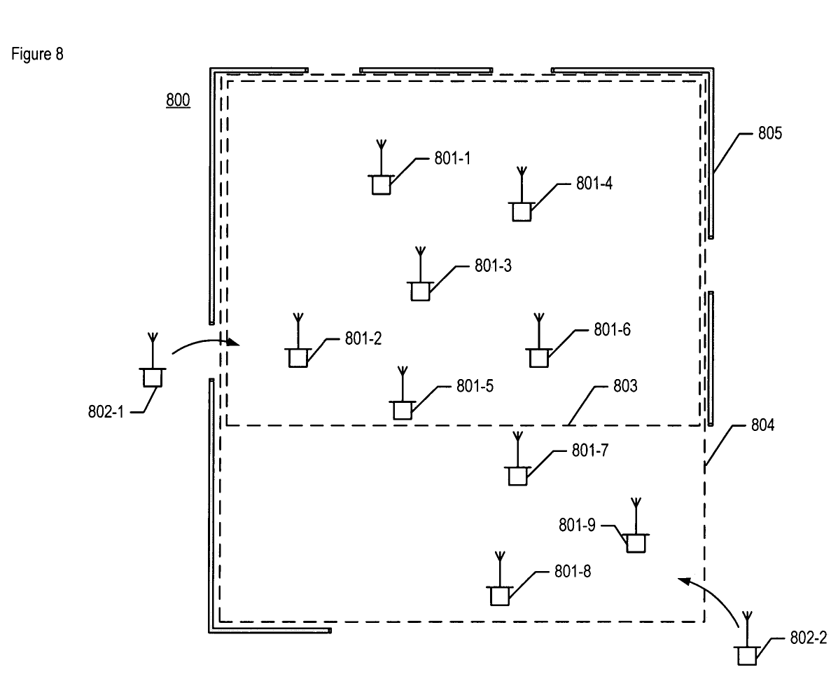

FIG. 8 depicts an illustrative example of the locations of several wireless terminals in network 800, in accordance with the illustrative embodiment of the present invention. Each of wireless terminals 801-1 through 801-9 is communicating or has communicated with a concealed access point, though not all are communicating with a particular level of service (i.e., at a minimum quality level or better). For example, wireless terminal 801-6 is communicating (or has communicated) with a particular level of service for throughput, but wireless terminal 801-1 is not. Wireless terminals 802-1 and 802-2 are about to enter the area served by the access point.

The area depicted comprises regions 803 and 804 that are described later and represents airport terminal 805 with openings allowing access from airplanes and openings from other areas that are not shown. Users of wireless terminals 801-1 through 801-9 have traveled into the terminal area from different places (e.g., airplanes, security checkpoints, etc.) and are depicted to be at various locations (e.g., sitting in waiting areas, standing at kiosks, etc.). The depicted locations of wireless terminals 801-1 through 801-9 also reflect the locations in effect when network 800 determines whether or not each wireless terminal is able to communicate with the access point with one or more a particular levels of service. Note that some of the depicted locations are of wireless terminals that communicated with the access point at an earlier time (e.g., two days ago, etc.).

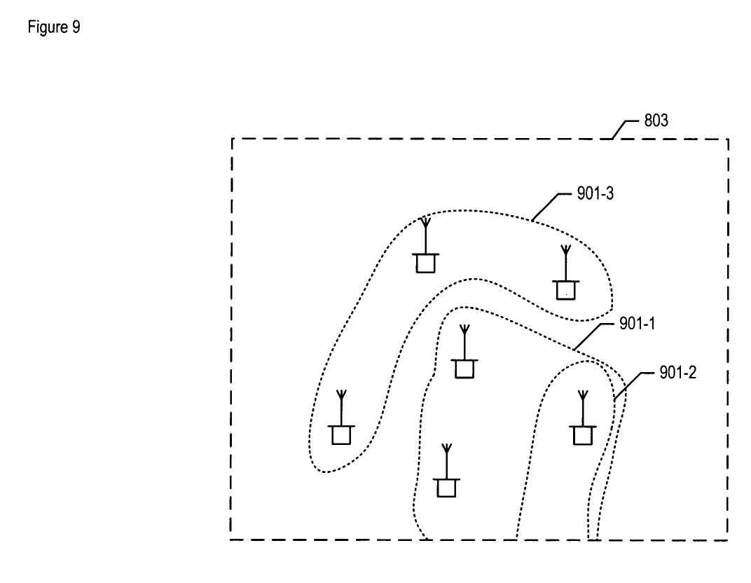

FIG. 9 depicts a first example of a graphical map that is displayable by display 405-1 of wireless terminal 802-1. The graphical map is generated from a subset of the wireless terminal locations depicted in FIG. 8 and displays region 803, in accordance with the illustrative embodiment of the present invention. Network 800 transmits to wireless terminal 802-1 a set of information in the form of the graphical map. The set of information comprises information the enables the user to determine where to find acceptable levels of service within area 803 for the characteristics of interest. Network 800 has generated the set of information by using information gathered from wireless terminals 801-1 through 801-6 and possibly other wireless terminals as well. In the example provided, network 800 has organized the location and level of service information into displayable zones 901-1, 901-2, and 901-3. It will be clear to those skilled in the art how to construct a graphical map to “smooth” individual points of data into zones.

Zones 901-1, 901-2, and 901-3 comprise locations at which particular levels of service expressed in terms of one or more characteristics can be experienced. Zone 901-1 represents an area in which one or more wireless terminals over time have experienced error rate performance better than a specific threshold. Zone 901-2 represents an area in which one or more wireless terminals over time have experienced both bit error rate performance and throughput performance better than their respective, specific thresholds. Zone 901-3 represents an area in which one or more wireless terminals over time have experienced performance worse than the specific threshold. The graphical map in FIG. 9 also portrays the specific locations of the evaluated wireless terminals (i.e., 801-1 through 801-6). The user of wireless terminal 802-1 can use the graphical map to find a zone associated with an acceptable level of service characteristic, even if the user is enable to move to the exact location of an evaluated wireless terminal (e.g., wireless terminal 801-6, etc.).

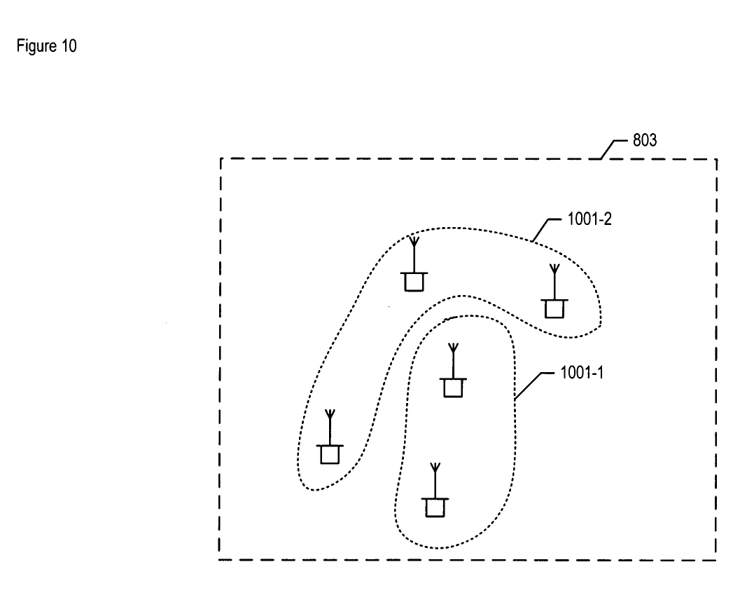

FIG. 10 depicts a second example of a graphical map that is displayable by display 405-1 of wireless terminal 802-1. The graphical map is generated from the wireless terminal locations depicted in FIG. 8 as a function of time and displays region 803, in accordance with the illustrative embodiment of the present invention. Zones 1001-1 and 1001-2 comprise locations at which particular levels of service expressed in terms of one or more characteristics can be experienced. Measurement data that is older than a certain amount of time (e.g., greater than one day, etc.) have been discarded; in the example, measurement data from wireless terminal 801-6 are old and, as a result, have been discarded. Zone 1001-1 represents an area in which one or more wireless terminals in the recent past have experienced error rate performance better than a specific threshold. No wireless terminals in the recent past have experienced both bit error rate performance and throughput performance better than their respective, specific thresholds (as in zone 901-2). Zone 1001-2 represents an area in which one or more wireless terminals in the recent past have experienced performance worse than the specific threshold.

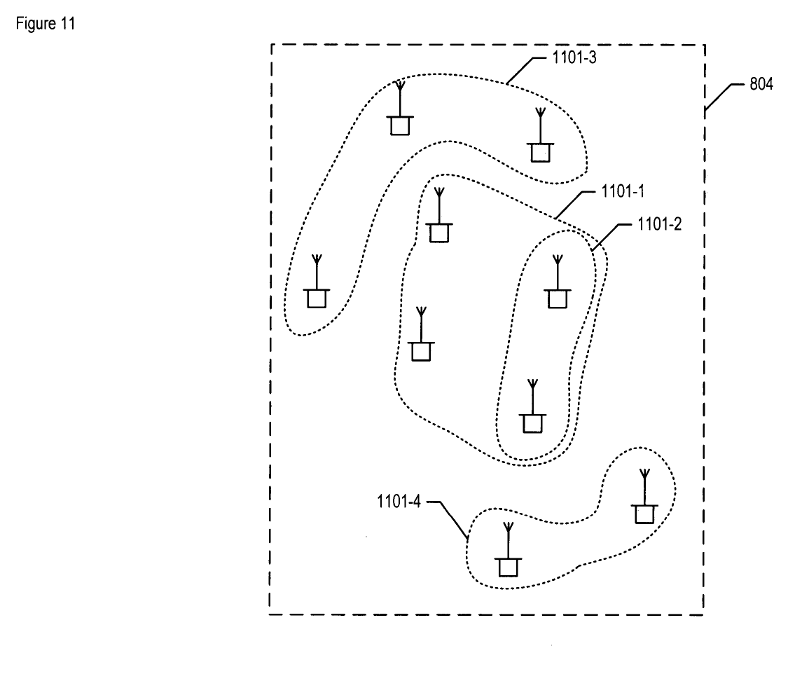

FIG. 11 depicts a third example of a graphical map that is displayable by display 405-2 of wireless terminal 802-2. The graphical map is generated from wireless terminals 801-1 through 801-9 depicted in FIG. 8 as a function of the capability of the displaying wireless terminal and, as a result, is able to portray region 804, in accordance with the illustrative embodiment of the present invention. Wireless terminal 802-2 is more capable in terms of displaying information than wireless terminal 802-1 and, therefore, is able to display a larger set of displayable information (i.e., representing larger region 804, as opposed to smaller region 803), as depicted in FIG. 11. Zones 1101-1 through 1101-4 comprise locations at which particular levels of service expressed in terms of one or more characteristics can be experienced.

Network 800, in some embodiments, provides each wireless terminal the set of displayable information that is suitable for that particular wireless terminal. Wireless terminals 802-1 and 802-2, in other embodiments, both receive the same set of displayable information, but then display an amount of information that is based on their respective capabilities. It will be clear to those skilled in the art how to manage the set of displayable information based on the capability of the wireless terminal.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

1. A method comprising:
determining that a first wireless terminal at a location can communicate with a second wireless terminal with a level of service; and
transmitting to a third wireless terminal an indication that said third wireless terminal should be able to communicate with said second wireless terminal with said level of service at said location.

2. The method of claim 1 wherein said first wireless terminal and said third wireless terminal are different.

3. The method of claim 1 further comprising displaying said indication.

4. The method of claim 3 wherein displaying said indication occurs in the form of a graphical map, wherein said graphical map portrays said location.

5. The method of claim 3 wherein said third wireless terminal performs displaying said indication.

6. The method of claim 1 wherein said level of service is in terms of at least one of (i) throughput, (ii) error rate, and (iii) latency.

7. The method of claim 1 wherein the coordinates of said location are based on Global Positioning System measurements.

8. The method of claim 1 wherein said second wireless terminal is an IEEE 802.11 access point.

9. A method comprising:
receiving from a first wireless terminal a measurement of a characteristic of an electromagnetic signal radiated by a source, wherein said measurement is associated with a location; and
transmitting to a second wireless terminal an indication that said second wireless terminal should be able to receive at said location said electromagnetic signal with said characteristic exceeding a threshold.

10. The method of claim 9 wherein said first wireless terminal and said second wireless terminal are different.

11. The method of claim 9 wherein said electromagnetic signal conveys a data block.

12. The method of claim 11 wherein said source is an IEEE 802.11 access point and said data block constitutes a beacon frame.

13. The method of claim 9 wherein said indication constitutes a set of displayable information, wherein said set of displayable information comprises said location.

14. The method of claim 13 further comprising displaying at said second wireless terminal said set of displayable information.

15. The method of claim 13 wherein said set of displayable information is in the form of a graphical map, wherein the size of said set of displayable information is dependent on said second wireless terminal.

16. The method of claim 9 wherein said characteristic is one of (i) throughput, (ii) error rate, (iii) latency, and (iv) signal strength.

17. The method of claim 9 wherein the coordinates of said location are based on Global Positioning System measurements.

18. A method comprising:
receiving information comprising a location;
determining that a characteristic of a first electromagnetic signal transmitted by said first wireless terminal exceeds a threshold; and
transmitting to a second wireless terminal an indication that said second terminal should be able to communicate at said location with an access point such that said access point receives a second electromagnetic signal transmitted by said second wireless terminal with said characteristic exceeding said threshold.

19. The method of claim 18 wherein said first wireless terminal and said second wireless terminal are different.

20. The method of claim 18 wherein said first electromagnetic signal conveys a data block.

21. The method of claim 18 wherein said access point performs measuring said characteristic.

22. The method of claim 18 wherein said indication constitutes a set of displayable information, wherein said set of displayable information comprises said location.

23. The method of claim 22 further comprising displaying at said second wireless terminal said set of displayable information.

24. The method of claim 22 wherein said displayable information is in the form of a graphical map, wherein the size of said set of displayable information is dependent on said second wireless terminal.

25. The method of claim 18 wherein said characteristic is one of (i) throughput, (ii) error rate, (iii) latency, and (iv) signal strength.

26. An apparatus comprising:
a processor for determining that a first wireless terminal at a location can communicate with a second wireless terminal with a level of service; and
a transmitter for transmitting to a third wireless terminal an indication that said third wireless terminal should be able to communicate with said second wireless terminal with said level of service at said location.

27. The apparatus of claim 26 wherein said first wireless terminal and said third wireless terminal are different.

28. The apparatus of claim 26 further comprising a display for displaying said indication.

29. The apparatus of claim 28 wherein displaying said indication occurs in the form of a graphical map, wherein said graphical map portrays said location.

30. The apparatus of claim 26 wherein said level of service is in terms of at least one of (i) throughput, (ii) error rate, and (iii) latency.

31. The apparatus of claim 26 wherein said second wireless terminal is an IEEE 802.11 access point.

32. An apparatus comprising:
a receiver for receiving from a first wireless terminal a measurement of a characteristic of an electromagnetic signal radiated by a source, wherein said measurement is associated with a location; and
a transmitter for transmitting to a second wireless terminal an indication that said second wireless terminal should be able to receive at said location said electromagnetic signal with said measurement exceeding a threshold.

33. The apparatus of claim 32 wherein said first wireless terminal and said second wireless terminal are different.

34. The apparatus of claim 32 wherein said electromagnetic signal conveys a data block.

35. The apparatus of claim 34 wherein said source is an IEEE 802.11 access point and said data block constitutes a beacon frame.

36. The apparatus of claim 32 wherein said indication constitutes a set of displayable information, wherein said set of displayable information comprises said location.

37. The apparatus of claim 36 further comprising a display at said second wireless terminal for displaying said set of displayable information.

38. The apparatus of claim 36 wherein said set of displayable information is in the form of a graphical map, wherein the size of said set of displayable information is dependent on said second wireless terminal.

39. The apparatus of claim 32 wherein said characteristic is one of (i) throughput, (ii) error rate, (iii) latency, and (iv) signal strength.
